(19) United States
(12) Patent Application Publication
(10) Pub. No.: US 2024/0135464 A1
(43) Pub. Date: Apr. 25, 2024

(54) SYSTEM AND METHOD FOR ANALYZING AND SELECTING COMPATIBLE RELATIONSHIP PAIRINGS BETWEEN USERS IN A RELATIONSHIPS ANALYTICS PLATFORM

(71) Applicant: Olajide Gamu, Stafford, VA (US)

(72) Inventor: Olajide Gamu, Stafford, VA (US)

(21) Appl. No.: 18/047,438

(22) Filed: Oct. 18, 2022

(51) Int. Cl. G06Q 50/00

(52) U.S. Cl. CPC G06Q 50/01

(57) ABSTRACT

A method and system for analyzing and selecting compatible relationship pairings between users in a relationship analytics platform that measures an individual user's personal growth and self-awareness while simultaneously measuring the dating and relationship building process based on observable data associated with the time, money and effort spent on dating a potential partner, as well as dating compatibility based on measurable experiences in redescribed areas of relationship importance.

### CROSS-REFERENCE TO RELATED APPLICATION

Not Applicable.

### TECHNICAL FIELD

The present invention relates generally to the field of dating communications. More specifically, the present invention relates to a system and method for analyzing and selecting compatible relationship pairings between users of an online social dating platform.

### BACKGROUND

In today's society, people engage with one another on a variety of social platforms such as Instagram®, Facebook®, Snapchat®, Twitter® and the like. As online socializing has grown, so has online dating. From Match.com® to E-Harmony®, people have turned to online social platforms in hopes of finding a lifelong partner. Yet in still, dating continues to be one of the most frustrating inter-personal relationships to master. As societal norms modify and grow, so do the requirements and expectations of a life partner.

Traditional online dating platforms allow a user to create a personal profile, select the ideal profile and likes/dislikes of a potential partner, and then allow the user to navigate and search the platform and the profiles of other users in hopes of randomly finding an ideal match. Although there are over 300 online social platforms that allow users to network and engage one another, these platforms do not allow users to measure and quantify the amount of time, attention, and money any given user has committed to a potential partner while simultaneously measuring whether the potential partner is an ideal match based on key categories that have been proven to indicate the compatibility between two individuals and encouraging the user to improve his/her on personal level.

The problem of how to find an ideal match on a social networking platform has been addressed in such disclosures such as U.S. Pat. No. 9,824,123 B2 (and its progeny), which generally discloses a system and method for finding users in a networked environment. Although this disclosure allows a user to engage in an improved matchmaking platform by utilizing a statistical/predictive algorithm, it does not, however, teach to a dating platform that allows a user to measure the time, money and attention given to a potential partner, nor does the disclosure teach a dating platform that measures the compatibility between two potential partners.

Another attempt can be seen in disclosures such as U.S. Pat. No. 9,733,811 B2 which generally discloses a dating matching process system and method based on certain preference indications. This disclosure does not, however, teach to a dating platform that allows a user to measure the time, money and attention given to a potential partner, nor does the disclosure teach a dating platform that measures the compatibility between two potential partners.

Similarly, disclosures such as the E-Harmony® platform (U.S. Pat. No. 6,635,568 B1) generally teach to a method and system for identifying people who are likely to have a successful relationship based on the one-time assessment of responses to predetermined questions to determine a potential successful relationship match, however, these disclosures do not teach to a method and system for measuring the compatibility between users based on continuous data input by users while simultaneously measuring the time, money, and effort given to a potential compatible partner in an attempt to allow the user to make a fully informed decision regarding a potential relationship pairing.

Yet another attempt can be seen in disclosures such as “Hello Relish”, which generally discloses a dating training platform. Although the disclosure teaches a dating platform that encourages users to improve themselves while utilizing the platform, it does not teach to a dating platform that allows a user to measure the time, money and attention given to a potential partner, nor does the disclosure teach a dating platform that measures the compatibility between two potential partners.

Other platforms such as LinkedIn® and Avvo® teach to methods and systems for reputation evaluation (U.S. Pat. No. 8,010,460 B2) and attribute rating systems (U.S. Patent Application No. 2014/0257939 A9), however these disclosures are limited to the evaluation and ratings of an individual's competence in a specific industry rather than the individual's relational compatibility with another.

Various attempts have been made to solve the problems which may be found in the related art but have been unsuccessful. A need exists for a novel dating platform that measures interactive effort, dating compatibility, and assists with personal improvement. The present invention provides method and system for measuring the data-based analytical compatibility between users based on continuous data input by users while simultaneously measuring the time, money, and effort given to a potential compatible partner in an attempt to allow the user to make a fully informed decision regarding a potential relationship pairing.

### BRIEF SUMMARY OF THE INVENTION

Certain embodiments commensurate in scope with the original claims subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed in the present disclosure by name, such as relationship, dating, compatibility, and so forth, are herein meant to include or encompass all equivalents for such elements. For example, in addition to a “Relationship Analytics Platform”, any online platform capable of connecting users is contemplated for any illuminating element in connection with the present invention. Such equivalents are contemplated for each element named in its particular herein.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel solution for a relationship pairing platform that measures interactive effort, dating compatibility, and assists with personal improvement. The general purpose of the present invention, which shall be described subsequently in greater detail, is to allow a user to measure the dating compatibility between the user and a potential partner while simultaneously measuring the time, effort, and money spent while dating and developing a relationship with a potential partner.

The features of the invention which are believed to be novel and particularly pointed out and distinctly claimed in the concluding portion of the specification. These and other features, aspects, and advantages of the present invention will become better understood with reference to the following drawings and detailed description.

The present invention measures an individual User's personal growth and self-awareness while simultaneously measuring the romantic relationship building process based on empirical, observable, and quantifiable data associated, by example, with the time, money and effort spent on dating a potential partner, as well as relational compatibility based on measurable experiences in the relationship areas of courtship, companionship, partnership, and Inspirationship (“Relationship Areas”).

In a preferred embodiment of the present invention, the Relationship Analytics Platform utilizes and individual User's Interactive Feedback and Compatibility Pairing metrics to measure the effort spent on interacting with a particular User and the relationship compatibility of the particular User.

To operate and engage the Relationship Analytics Platform, a User creates a User profile and answers a series of questions, the answers to which are used generate the User's initial Analytic Score. Users then receive suggested Compatible Analytic Score Searches based on the initial Analytic Score data as compared to the Analytic Score data of other Users. When a User elects to request a connection with a suggested Compatible Analytic Score User, and if such a request is mutual, the Users then have the option of communicating through the Relationship Analytics Platform to get to know one another. Each Interaction may be logged and tracked in the Relationship Analytics Platform to measure the amount of time invested in each User, the amount of money spent on each Interaction, as well as communication, energy, and emotional intimacy efforts of each Interaction. Each Interaction may also be managed through the Relationship Analytics Platform's calendar. When a User has amassed sufficient empirical, observable, and quantifiable data of each Compatible Analytic Score User that said User has Interacted with, that User may then be able to select a final compatibility pairing that best suits the User's preferences.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

### BRIEF DESCRIPTION OF THE DRAWINGS

FIG. 1 is a flow diagram illustrating the process steps for computing initial analytic compatibility pairings between two or more users in a Relationship Analytics Platform based on an individual user's analytic score.

FIG. 2 is a flow diagram illustrating the process steps for segregating analytic compatibility pairings between two or more users in a Relationship Analytics Platform.

FIG. 3 is a flow diagram illustrating the process steps for recalculating a user's analytic score and computing new analytic compatibility pairings between two or more users in a Relationship Analytics Platform.

FIG. 4 is a flow diagram illustrating the process steps for managing a select data set of segregated compatibility pairings between two or more users in a Relationship Analytics Platform in accordance with an embodiment of the present invention.

FIG. 5 is a flow diagram illustrating the process steps for managing a select data set of segregated compatibility pairings between two or more users in a Relationship Analytics Platform in accordance with an embodiment of the present invention.

FIG. 6 is a flow diagram illustrating the process steps of evaluating the analytic compatibility pairings between two or more users in a Relationship Analytics Platform based on evaluation data in accordance with an embodiment of the present invention.

Numerous advantages and aspects of the invention will be apparent to those skilled in the art upon consideration of the following detailed description taken in conjunction with the drawings which generally provide illustrations of the invention in its preferred embodiments as they relate to dating platforms and social networking.

### DETAILED DESCRIPTION

### Abbreviations and Definitions

Analytic Score: as used herein, the term “Analytic Score” refers to Relationship Area behavioral outputs, assigned to numerical values, that accumulate to a total.

Analytic Score Comparison: as used herein, the term “Analytic Score Comparison” refers to the comparison between the Analytic Score of one User as compared to the Analytic Score of another User. By way of non-limiting example, User A may be paired with User B if the Analytic Scores of each User falls within a pre-determined value (+/−) difference.

Courtship: as used herein, the term “Courtship” describes the physical attraction, psychological chemistry, and desire for another individual User.

Companionship: as used herein, the term “Companionship” describes mutual interests and levels of comfort over shared periods of time between two Users.

Compatible Analytic Score Search: as used herein, the term “Compatible Analytic Score Search” refers to the User accessible database of other Users whose Analytic Scores fall within a pre-determined value (+/−) difference.

Compatibility Pairing or Romantic Compatibility Pairing: as used herein, the term “Compatibility Pairing” or “Romantic Compatibility Pairing” refers to the data set of Users that are most closely identified as compatible with a single User based on the empirical and analytic data accumulated through User-to-User Interaction Feedback.

Inspirationship: as used herein, the term “Inspirationship” describes the ability for a User to inspire another User to improve that User's life.

Interaction: as used herein, the term “Interaction, refers to a communication or direct contact between two Users. An Interaction may also be referred to as a User-to-User Interaction.

Interaction Feedback: as used herein, the term “Interaction Feedback” refers to collected numerical data following an Interaction and based on a User's response or grading of the other User.

Partnership: as used herein, the term “Partnership” describes a User's potential to build a future with another User based on that User's envisioned lifestyle, passion, and values.

Rankings: as used herein, the term “Rankings” refers to either the manual or analytical prioritization of a Compatibility Pairing based in personal preference or empirical and quantifiable data, respectfully.

Relational Analytic Protocol or Dating Analytic Protocol: as used herein the term “Relational Analytic Protocol” or “Dating Analytic Protocol” refers to the initial Self-Awareness Score derived from a User's Self-Assessment Data Input.

Threshold: as used herein, the term “Threshold” or “Feedback Threshold” refers to the minimal number of Interaction Feedbacks required for Users to receive recalculated Analytic Scores.

User: as used herein, the term “User” or “Users” refers to a customer of the present Relationship Analytics Platform who has an active profile within the Relationship Analytics Platform.

User Self-Assessment Data: as used herein, the term “User Self-Assessment Data” refers to the responses to the Relationship Analytics Platform's onboarding questionnaire and associated empirical data.

User Self-Awareness Score: as used herein, the term “User Self-Awareness Score” refers to a numerical score calculated based on acquired data sets pertaining to relationship assessment areas of Courtship, Companionship, Partnership, and Inspirationship (“Relationship Areas”).

While the invention will be described in connection with dating and social networking, it is understood that the invention is not limited in scope to use with dating and social networking but may be used with objects having other configurations.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

As used in this disclosure, except where the context requires otherwise, the term “comprise” and variations of the term, such as “comprising,” “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may not be shown in detail in order not to obscure the embodiments.

The embodiments of the invention described herein are exemplary and numerous modifications, variations and rearrangements can be readily envisioned to achieve substantially equivalent results, all of which are intended to be embraced within the spirit and scope of the invention. Furthermore, while the preferred embodiment of the invention has been described in terms of the components and configurations, it is understood to that the invention is not intended to be limited to those specific dimensions or configurations but is to be accorded the full breadth and scope of the spirit of the invention.

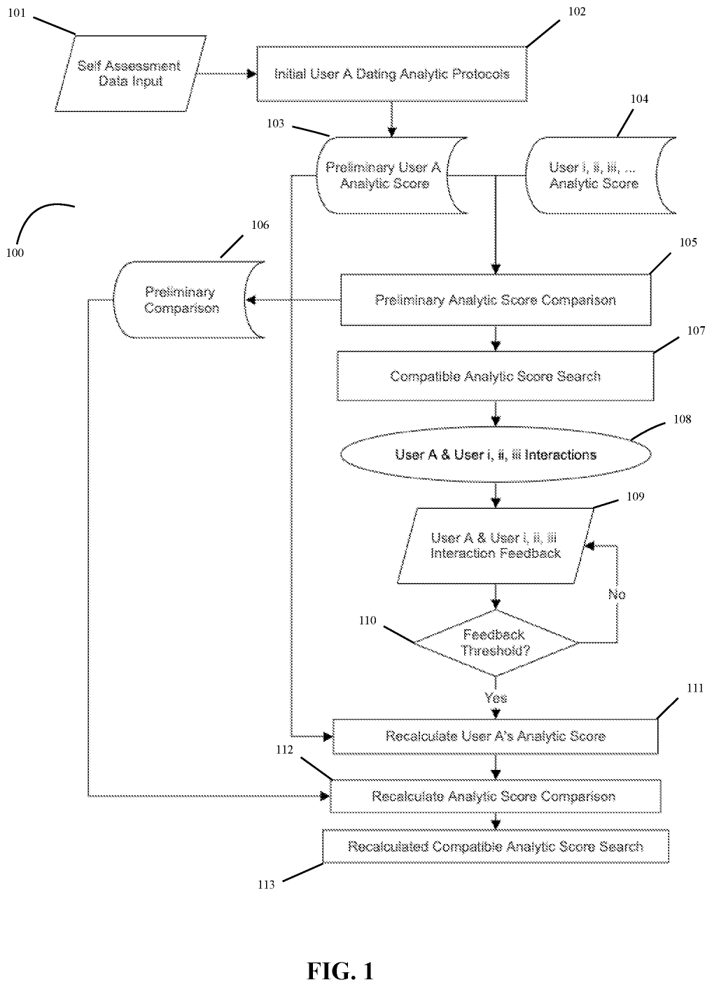

In FIG. 1, a flow diagram illustrating the process steps for computing initial analytic compatibility pairings between two or more users in a Relationship Analytics Platform based on an individual User's analytic score in accordance with an embodiment of the present invention is shown. In operation, the Relationship Analytics Platform 100 disclosed allows a User to identify an ideal romantic compatibility pairing by first obtaining the User's Self-Assessment Data 101. While the Self-Assessment Data 101 gathers generic information about a User's relationship interests (i.e., age, gender, activities, etc.), the initial Dating Analytic Protocols 102 generated from the Self-Assessment Data is an initial statistical measurement of a User's Self-Awareness Score. By way of non-limiting example, a User's Self-Awareness Score may be calculated (and recalculated) in view of the relationship assessment areas of Courtship, Companionship, Partnership, and Inspirationship (“Relationship Areas”). In some embodiments, a User's Self-Awareness Score may be rated as “High,” “Medium,” or “Low” in either an individual Relationship Area or in the aggregate.

In a preferred embodiment, the system and method 100 utilizes algorithms (not illustrated) to calculate a User's preliminary Analytic Score 103 which, when analyzed against other Users 104 (i.e. User i, ii, iii . . . ) generates a database of Compatibility Pairings through a preliminary Analytic Score Comparison 105, and constructs the empirical database of Preliminary Comparisons 106 across all Users of the Relationship Analytics Platform. In some embodiments, the preliminary Analytic Score Comparison 105 may be compiled into a searchable User database thereby enabling the User to conduct a Compatible Analytic Score Search 107.

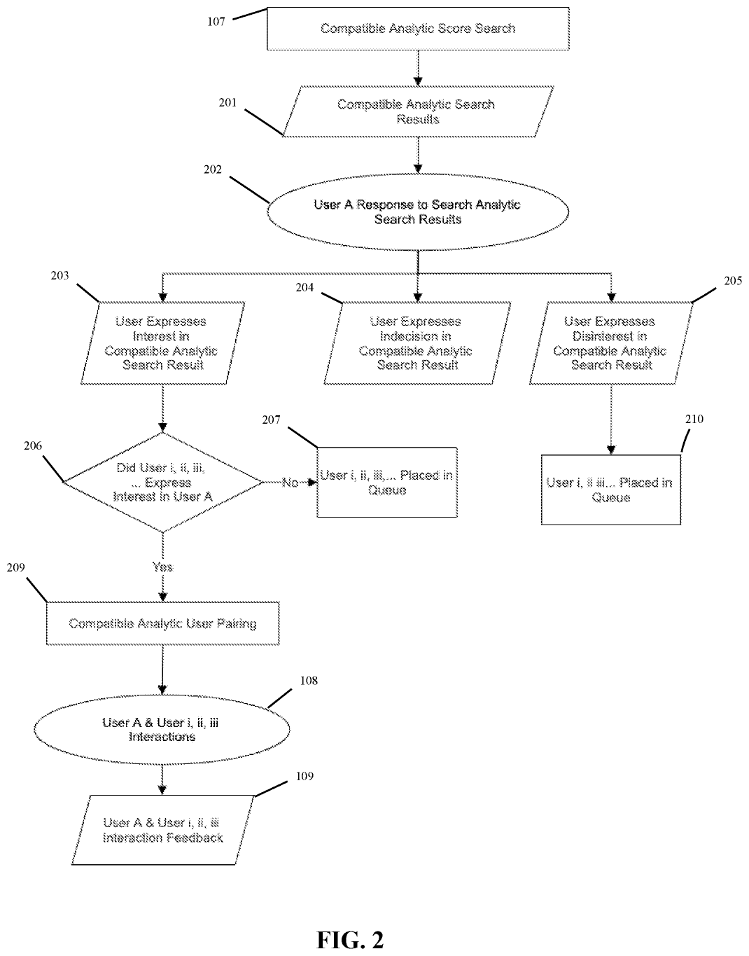

As shown in further detail in FIG. 2, User's who engage the Compatible Analytic Score Search 107 database are thereby able to initiate User-to-User Interactions 108 for the purpose of collecting Interaction Feedback 109. In some embodiments, a User may make record of the User-to-User Interaction 108 by adding it to the User's calendar within the Relationship Analytics Platform prior to the Interaction, or by noting the User-to-User Interaction 108 following such Interaction.

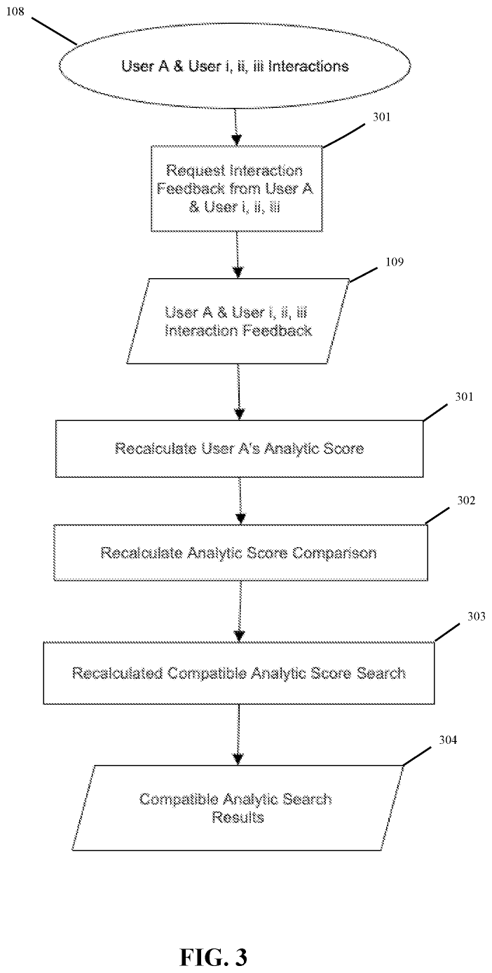

The Interaction Feedback 109 that is gathered at the conclusion of each User-to-User Interaction 108 may be used to recalculate 111 a User's Analytic Score 103 which, in turn, recalculates all prior User Analytic Score Comparisons 112 based on the empirical database of Preliminary Comparisons 106 once the User Feedback meets a pre-determined Feedback Threshold 110. Such recalculation is performed though a machine learning algorithm that utilizes all empirical and quantifiable data within the Relationship Analytics Platform. The recalculation of the User's Analytic Score Comparisons 112 then generates an algorithmically recalculated Compatible Analytic Score Search 113. In a preferred embodiment of the present invention, distinct from all prior art, and through machine learning, the continuous input of Interaction Feedback 109 continuously recalculates a User's Analytic Score 111 which thereby recalculates User-to-User Analytic Score Comparisons 112 and the corresponding Compatible Analytic Score Search 113. These continuous recalculations 111, 112, 113 (and as detailed FIG. 3 by 301, 302, 303) enable a User to view the most ideal Compatibility Pairing within the Relationship Analytics Platform based on analytical and empirical data, as derived through machine learning.

By way of a non-limiting example, “User A”, “User B”, “User C”, “User D”, etc. (the “Interacting Users”) may provide Interaction Feedback 109 for “User X” over the course of User-to-User Interactions 108 between “User X” and the Interacting Users. Such Interaction Feedback 109 is scored as empirical data and is constantly collected throughout User X's usage of the present invention, and constantly used by the machine learning algorithms to recalculate User X's Self-Awareness Score in each Relationship Area and, accordingly, User X's Analytic Score 111. Once recalculated, the machine learning algorithm of the present invention utilizes the empirical data to analyze and select the ideal compatible relationship pairing between the User X and other Users in the Relationship Analytics Platform.

Turning to FIG. 2 a flow diagram illustrating the process steps for segregating analytic compatibility pairings between two or more Users in a Relationship Analytics Platform is shown in accordance with an embodiment of the present invention. In the embodiment shown, a viewer may perceive that the Compatible Analytic Score Search 107 generates Compatible Analytic Search Results 201 that a User may review and respond to 202 by expressing interest 203 in a specific User from Compatibility Search Result 201, indecision 204 in a specific User from Compatibility Search Result 201, or disinterest 205 in a specific User from Compatibility Search Result 201.

In some embodiments, when viewing the Compatible Analytic Search Results 201 a User may view the profile of Compatible Analytic Search Results 201 which may include a photograph, a written summary of the User, the User's interests, disinterests, as well as a video profile of the User. In such an embodiment, the video of the User enables the viewing User to confirm that the Compatible Analytic Search Result 201 is a valid person and is who the User claims to be.

In another embodiment of the present invention, User-to-User Analytic Pairings 209 may only occur if both Users express a mutual interest in one another 206. Once paired the Paired Users 209 may elect to proceed with User-to-User Interaction 108 and provide Interaction Feedback 109.

As seen in FIG. 3 the present invention may recalculate a User's Analytic Score and computing new analytic Compatibility Pairings between two or more Users. Following a User-to-User Interaction 108, a User may voluntarily provide Interaction Feedback 109 or may be requested to provide Interaction Feedback 301 through the Relationship Analytics Platform following a User-to-User Interaction 108.

In some embodiments, the Relationship Analytics Platform allows Users to engage in and/or initiate User-to-User Interactions 108 within the Relationship Analytics Platform. By way of non-limiting example, the Relationship Analytics Platform enables a User to call and message/text another User exclusively within the Relationship Analytics Platform without the necessity of exchanging phone numbers. In other embodiments, the Relationship Analytics Platform enables Users to schedule in-person User-to-User Interactions 108 directly with participating venues (i.e., bars, restaurants, lounges, movie theaters, etc.), whereby the corresponding Interaction data is collected as empirical data within the Relationship Analytics Platform.

Through a machine learning algorithm, the Interaction Feedback 109 that is gathered at the conclusion of each User-to-User Interaction 108 may be used to recalculate a User's Analytic Score 301 which, in turn, recalculates all prior User Analytic Score Comparisons 302 based on the empirical database of Preliminary Comparisons 106 (not shown). The recalculation of the User's Analytic Score Comparisons 302 then generates a recalculated Compatible Analytic Score Search 303. In a preferred embodiment of the present invention, and distinct from all prior art, the continuous input of Interaction Feedback 109 continuously recalculates a User's Analytic Score 301 which thereby recalculates User-to-User Analytic Score Comparisons 302 and the corresponding Compatible Analytic Score Search 303. These continuous recalculations 301, 302, 303 enable a User to view the most ideal Compatibility Pairing within the Relationship Analytics Platform based on analytical and empirical data, as derived through machine learning.

In some embodiments, the Interaction Feedback 109 recalculates a User's Analytic Score 301 which is comprised of a User's Self-Awareness Score in each Relationship Area, which may be rated as “High,” “Medium,” or “Low,” either individually or in the aggregate (the Relational Average”). The Relationship Analytics Platform 100 compares each User's Analytic Score 301 and Relational Average against the Analytic Score 301 and Relational Average of other Users within the Relationship Analytics Platform. By way of non-limiting example:

| | | | | | Re- |
|---|---|---|---|---|---|
| | Court- | | Part- | | lational |
| | ship | Companionship | nership | Inspirationship | Average |
| User | 9.20 | 5.45 | 8.80 | 8.35 | 7.95 |
| X | (High) | (Low) | (High) | (High) | (Me- |
| | | | | | dium) |
| User | 6.20 | 8.45 | 7.35 | 5.20 | 6.80 |
| Y | (Medium) | (High) | (Medium) | (Low) | (Low) |

The Relationship Analytics Platform may produce an Analytic Score Comparison 302 based on (1) whether the User's Analytic Score 301 falls within a pre-determined value (+/−) difference of another User's Analytic Score 301 and (2) whether the User's Relational Average falls within a pre-determined value (+/−) difference of the other User's Relational Average.

In some embodiments, a User may elect to view a Compatible Analytic Score Search 303 based solely on the machine learning algorithms or may elect to view the Compatible Analytic Score Search 303 based on a User's personal preference. By way of non-limited example, a User may elect to have the Relationship Analytics Platform produce an Analytic Score Comparison 302 based on the difference of 1 point between User's Analytic Score 301 and another User's Analytic Score 301 or where the Users' Analytic Scores 301 are equal.

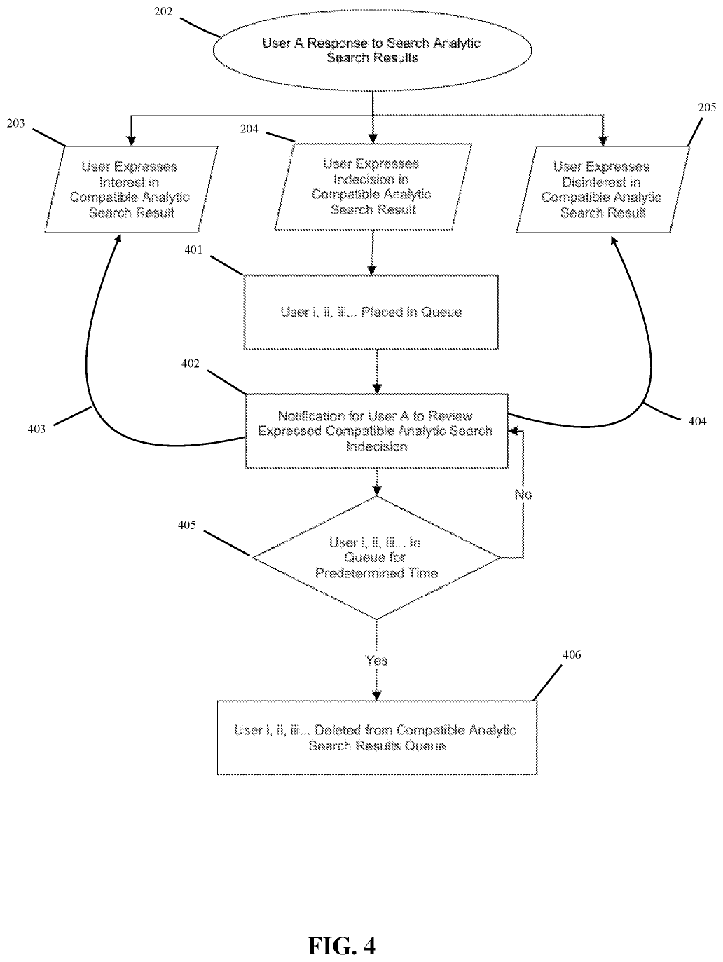

In FIG. 4, a flow diagram illustrating the process steps for managing a select data set of segregated compatibility pairings between two or more Users in a Relationship Analytics Platform in accordance with an embodiment of the present invention is shown. In the embodiment shown, a viewer may perceive that a User may review and respond 202 to search result by expressing interest 203 in a specific User from the Compatibility Search Result 201, indecision 204 in a specific User from the Compatibility Search Result 201, or disinterest 205 in a specific User from the Compatibility Search Result 201. Where a User expresses indecision 204 in a specific User (the “Undecided Pairing”) from the Compatibility Search Result 201, the Undecided Pairing is placed in a queued database 401 until the User expresses interest 403 in the Undecided Pairing, expresses disinterest 404 in the Undecided Pairing, or until the passage of a predetermined measure of time whereby the Undecided Pairing will be deleted from the User's Compatible Analytic Search Results Queue 406 and, ultimately, any Compatibility Search Results 201 of either User. Where the User does not voluntarily move an Undecided Pairing from the “indecision queue” to either an expressed interest 403 or expressed disinterest 404 status, the User will receive a notification 402 to inform the User that only a predetermined measure of time remains until the Undecided Pairing is will be deleted from the User's Compatible Analytic Search Results Queue 406 and, ultimately, any Compatibility Search Results 201 of either User.

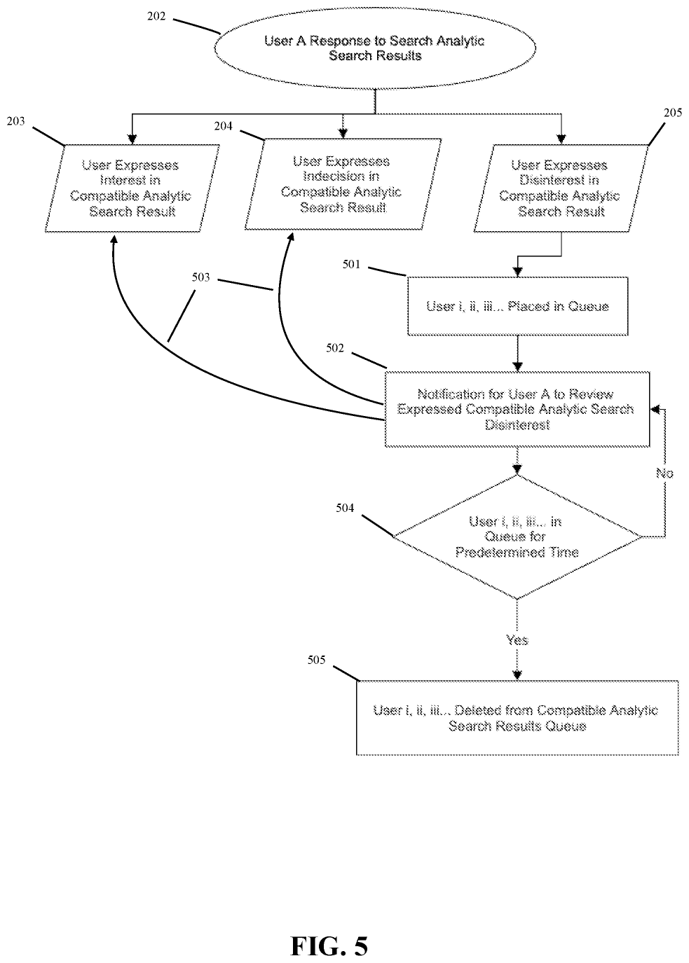

Similarly, in FIG. 5, a flow diagram illustrating the process steps for managing a select data set of segregated disinterested compatibility pairings between two or more users in a Relationship Analytics Platform in accordance with an embodiment of the present invention is shown. In the embodiment shown, a viewer may perceive that a User may review and respond 202 to a search result by expressing interest 203 in a specific User from the Compatibility Search Result 201, indecision 204 in a specific User from the Compatibility Search Result 201, or disinterest 205 in a specific User from the Compatibility Search Result 201. Where a User expresses disinterest 205 in a specific User (the “Unwelcome Pairing”) from the Compatibility Search Result 201, the Unwelcome Pairing is placed in a queued database 501 until the User expresses interest or indecision 503 in the Unwelcome Pairing, or until the passage of a predetermined measure of time whereby the Unwelcome Pairing will be deleted from the User's Compatible Analytic Search Results Queue 505 and, ultimately, any Compatibility Search Results 201 of either User. Where the User does not voluntarily move an Unwelcome Pairing from the “disinterested queue” to either an expressed interest or indecision 503 status, the User will receive a notification 502 to inform the User that only a predetermined measure of time remains until the Unwelcome Pairing is will be deleted from the User's Compatible Analytic Search Results Queue 505 and, ultimately, any Compatibility Search Results 201 of either User.

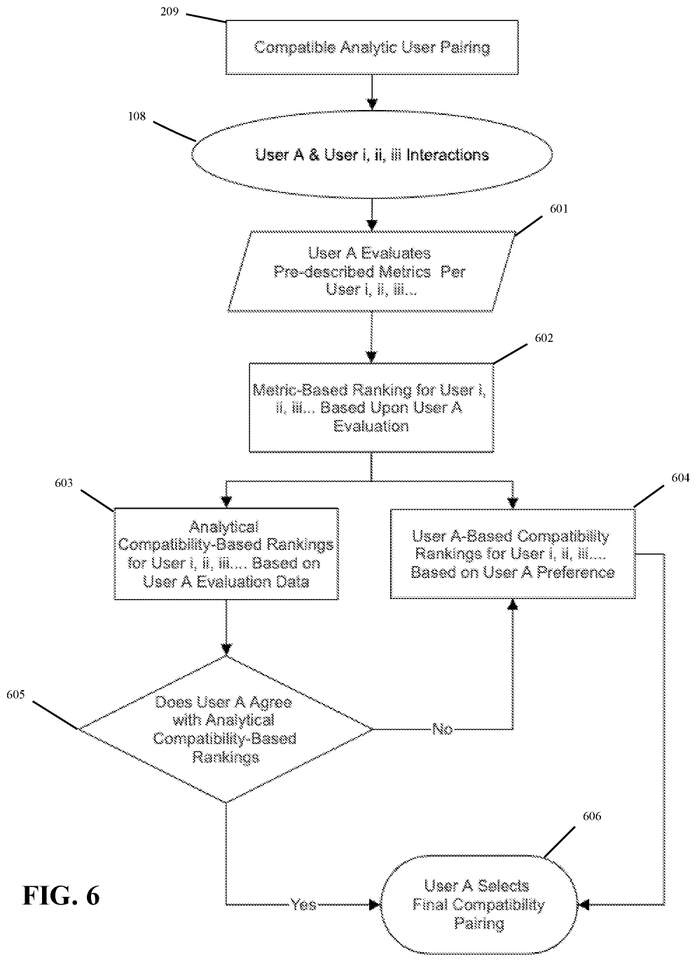

In a preferred embodiment of the present invention, and as illustrated in FIG. 6, the Relationship Analytics Platform evaluates the analytic compatibility pairings between two or more Users given the empirical, observable, and quantifiable data such as the time, money and effort spent on interacting with another User, as well as relational compatibility based on measurable experiences in the relationship areas of courtship, companionship, partnership, and Inspirationship (“Relationship Areas”). Following a Compatible Analytic User Pairing 209 and subsequent User-to-User Interaction 108, a User may evaluate 601 a paired Compatible Analytic User in metrics such as the time, money, and effort spent on interaction with the paired Compatible Analytic User. Such metrics enable a User to review the true relational compatibility of another User based on empirical, observable, and quantifiable data. The machine learning algorithms of the present invention utilizes such empirical, observable, and quantifiable data and ranks 602 the paired Compatible Analytic User alongside other paired Compatible Analytic Users based on, by way of example, the time, money, and effort spent on each paired Compatible Analytic User.

In some embodiments, the present invention allows a User to sort the User's paired Compatible Analytic Users based on User preference 604, while simultaneously providing the User with the ideal paired Compatible Analytic User rankings based on the empirical and quantifiable data 603. The User may agree with the paired Compatible Analytic User rankings based on the empirical and quantifiable data 603 or may rely solely on the User's paired Compatible Analytic Users based on User preference 604 to select a final compatibility pairing. 606.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the invention generally described herein has been disclosed in connection with a number of embodiments shown and described in detail, various modifications should be readily apparent to those of skill in the art.

What is claimed is:

1. A method for analyzing and selecting compatible relationship pairings between users in a relationship analytics platform, the method comprising the steps of:
determining the analytic score of a plurality of users within the relationship analytics platform;
determining the analytic score difference between a plurality of users with the relationship analytics platform;
determining the relational compatibility between a plurality of users within the relationship analytics platform;
generating analytic compatibility pairings between a plurality of users within the relationship analytics platform; and
determining the ranking of at least two analytic compatibility pairings between a plurality of users within the relationship analytics platform.

2. The method of claim 1, whereby the analytic score and relational compatibility are numerical.

3. The method of claim 2, whereby the numerical representations of the analytic score and relational compatibility may be determined by a series of computations derived from empirical data, user input data, and quantifiable metric data.

4. The method of claim 2, whereby the numerical representation of the analytic score and relational compatibility may be received as at least one sequence of data, wherein said sequence of data may be maintained in a historical database.

5. The method of claim 1, whereby an analytic score of the plurality of users within the relationship analytics platform may be determined by at least one categorical data input the plurality of users.

6. The method of claim 5, whereby the at least one categorical data input is user self-assessment data.

7. The method of claim 5, whereby the at least one categorical data input is user self-awareness data.

8. The method of claim 1, whereby the analytic score divergence between a plurality of users may be determined by the calculation of the numerical difference between the analytic score of at least one user as compared to the analytic score of the remaining individual users.

9. The method of claim 1, whereby relational compatibility between a plurality of users may be determined by the divergence from the preferred numeric representation of relational compatibility an individual user and the analytic score.

10. The method of claim 1, whereby the analytic compatibility pairings between a plurality of users within the relationship analytics platform may be generated from the selection of users having a pre-determined numerical representation of divergence in analytic score and relational compatibility.

11. The method of claim 1, whereby the generated analytic compatibility pairings between a plurality of users within the relationship analytics platform may be searched by an individual user.

12. The method of claim 1, whereby the ranking of at least two analytic compatibility pairings between a plurality of users may be determined by calculating the analytic score difference, the relational compatibility of at least two analytic compatibility pairings, and the calculation of metric-based quantifiable data of at least one analytic compatibility pairing as compared to at least one other analytic compatibility pairing.

13. The method of claim 1, whereby the analytic score and analytic score difference may be recalculated following the categorization of user-driven numerical input data, thereby regenerating analytical compatibility pairings and the ranking of at least two analytic compatibility pairings between a plurality of users within the relationship analytics platform.

14. The method of claim 12, whereby the user selects the preferred analytic compatibility pairing.

15. A system for analyzing and selecting compatible relationship pairings between users in a relationship analytics platform, the method comprising the steps of:
one or more processors; and a data storage coupled to one or more processors, having instructions stored thereon which, when executed by at least one processor, causes the one or more processors to perform operations comprising:
receiving analytic score data of at least two users within the relationship analytics platform;
identifying the analytic score difference between at least two users with the relationship analytics platform;
identifying the relational compatibility between at least two users within the relationship analytics platform;
generating analytic compatibility pairings between at least two users within the relationship analytics platform; and
generating the ranking of at least two analytic compatibility pairings within the relationship analytics platform.

16. The system of claim 15, whereby the numerical representations of the analytic score and relational compatibility may be received as at least one sequence of data, wherein said sequence of data may be maintained in a historical database.

17. The system of claim 16, wherein the system is configured to classify the at least one sequence of data and the system is respectively trained to use the at least one sequence of data as a training data set.

18. The system of claim 15, whereby the system is configured to compute the divergence between the numerical representation and a second set of at least one other sequence of data, wherein the second set of at least one other sequence of data comprises the analytic score difference and relational compatibility of at least two users.

19. The system of claim 18, whereby the system analyzes the computed divergence between the numeric representation and the second set of at least one other sequence of data, and generates a compatibility pairing between at least two users within the relationship analytics platform based on the computed divergence.

20. A non-transitory computer-readable medium stoting program that causes a processor to:
receive analytic score data of at least two users within the relationship analytics platform;
identify the analytic score difference between at least two users with the relationship analytics platform;
identify the relational compatibility between at least two users within the relationship analytics platform;
generate analytic compatibility pairings between at least two users within the relationship analytics platform; and
generate the ranking of at least two analytic compatibility pairings within the relationship analytics platform.
